(19) United States
(12) Patent Application Publication
(10) Pub. No.: US 2011/0228203 A1
(43) Pub. Date: Sep. 22, 2011

(54) DISPLAY DEVICE PROVIDED WITH SPACER PARTICLES AND METHOD OF MANUFACTURING THE SAME

(75) Inventor: Haruhiko ISHIHARA, Kanagawa-ken (JP)

(73) Assignee: KABUSHIKI KAISHA TOSHIBA, Tokyo (JP)

(21) Appl. No.: 13/017,435

(22) Filed: Jan. 31, 2011

(30) Foreign Application Priority Data
Mar. 19, 2010 (JP) 2010-065221

(51) Int. Cl. G02F 1/1337; H01J 9/24

(52) U.S. Cl. 349/123; 445/24

(57) ABSTRACT

In one embodiment, droplets of a spacer dispersed solution are provided on portions of a surface of a substrate which is provided with electrode films with a space provided between the electrode films. The portions are above the space between the electrode films. The spacer dispersed solution is obtained by dispersing spacer particles in a solvent produced by mixing first and second solvents at least. The second solvent has a higher boiling point and a larger surface tension than those of the first solvent. The substrate is heated at a temperature lower than the boiling point of the first solvent so that the first solvent evaporates. The substrate is heated at a temperature higher than the boiling point of the first solvent and lower than the boiling point of the second solvent so that the second solvent evaporates so as to leave the spacer particles on the substrate.

### CROSS-REFERENCE TO RELATED APPLICATION (S) (Quotation of Related

This application is based upon and claims the benefit of priority from the prior Japanese Patent Application No. 2010-65221, filed on Mar. 19, 2010, the entire contents of which are incorporated herein by reference.

### FIELD

Embodiments described herein relate generally to a display device which is provided with spacer particles on a substrate and to a method of manufacturing the same.

### BACKGROUND

A display device such as a liquid crystal display or a FED (Field Emission Display) is provided with spacer particles which are arranged between a pair of substrates, in order to keep the interval between substrates at a constant value throughout the whole area. A method of arranging spacer particles on a substrate in a display device is disclosed in JP2007-114312A, for example.

The arranging method disclosed in the patent document will be explained referring to FIGS. 4A-4D. The method is presented to arrange spacer particles on a substrate of a liquid crystal display device. As shown in FIG. 4A, a spacer dispersed solution 106 is applied on an alignment film 103 formed on a substrate 101 of glass. Specifically, droplets of the spacer dispersed solution 106 are applied on respective portions of a surface of the alignment film 103 above a space sandwiched between transparent electrode films 102 formed on the substrate 101. The spacer dispersed solution 106 is obtained by dispersing spacer particles 105 in a solvent 104 which is produced by mixing first and second solvents.

Then, the spacer particles 105 are precipitated on the alignment film 103 formed on the substrate 101, as shown in FIG. 4B. Further, the spacer particles 105 are clumped while the first solvent of the spacer dispersed solution 106 is evaporated.

Then, the spacer particles 105 are clumped further while the second solvent is evaporated gradually, as shown in FIG. 4C. As a result, as shown in FIG. 4D, the spacer particles 105 are arranged on portions of the alignment film 103 located above a narrow space between the electrode films 102. A liquid crystal is provided between the alignment film 103 and another alignment film formed on an opposite glass substrate (not shown).

In the arranging method, the spacer particles 105 are clumped after the particles 105 are precipitated on the alignment film 103. In this case, fine projections 107 may exist above the circumference of the electrode films 102. The fine projections 107 are formed of dust, a washing remainder after the substrate 101 is washed, or a resist remainder produced at the time of manufacturing the liquid crystal display device, for example. The fine projections 107 may prevent the spacer particles 105 from moving to an area above the narrow space, and may cause part of the spacer particles 105 to remain on the electrode films 102, as shown in FIG. 4D. This can result in lowering reliability of the display device.

Specifically, bright or black points may arise on display due to the spacer particles remaining on the electrode films 102. The bright or black points are easy to become prominent as each of pixel areas is smaller. Further, the bright points are easy to become prominent as the thickness of the liquid crystal is smaller.

### BRIEF DESCRIPTION OF THE DRAWINGS

FIG. 1 is a sectional view showing an example of a liquid crystal display device.

FIG. 2 is a partial plane view of the liquid crystal display device of FIG. 1.

FIGS. 3A-3D are sectional views showing steps of a method of manufacturing a liquid crystal display device according to an embodiment, respectively.

FIGS. 4A-4D are sectional views showing steps of a method of manufacturing a conventional liquid crystal display device, respectively.

### DETAILED DESCRIPTION

According to one embodiment, a method of manufacturing a display device is provided. In the method, droplets of a spacer dispersed solution are provided on respective portions of a surface of a substrate which is provided with electrode films along the surface with a space provided between the electrode films. The portions are above the space between the electrode films. The spacer dispersed solution is obtained by dispersing spacer particles in a mixture solvent produced by mixing first and second solvents at least. The second solvent has a higher boiling point and a larger surface tension than those of the first solvent. The substrate is heated at a temperature lower than the boiling point of the first solvent so that the first solvent contained in the spacer dispersed solution evaporates. The substrate is heated at a temperature higher than the boiling point of the first solvent and lower than the boiling point of the second solvent after evaporation of the first solvent so that the second solvent contained in the spacer dispersed solution evaporates so as to leave the spacer particles on the substrate.

According to another embodiment, a method of manufacturing a display device is provided. first electrode films are provided on a surface of a first main body of a first substrate along the surface so as to provide a space between the first electrode films, and a first alignment film is formed to cover the first electrode films and the surface of the main body so that a first substrate is prepared. A second electrode film is provided on a surface of a second main body of a second substrate, and a second alignment film is formed on the second electrode film so that a second substrate is prepared. Droplets of a spacer dispersed solution are provided on portions of a surface of the first alignment film. The portions are above the space between the first electrode films. The spacer dispersed solution is obtained by dispersing spacer particles in a solvent produced by mixing first and second solvents at least. The second solvent has a higher boiling point and a larger surface tension than those of the first solvent. The first substrate is heated at a temperature lower than the boiling point of the first solvent so that the first solvent contained in the spacer dispersed solution evaporates. The first substrate is heated at a temperature higher than the boiling point of the first solvent and lower than the boiling point of the second solvent after evaporation of the first solvent so that the second solvent contained in the spacer dispersed solution evaporates so as to leave the spacer particles on the first substrate. The second substrate is contacted with the spacer particles so that the spacer particles are sandwiched between the first and the second alignment films.

According to further another embodiment, a display device is provided. A first substrate has a first main body, first electrode films and a first alignment film. The first electrode films are provided along a surface of the first main body with a space between the first electrode films. The first alignment film is formed to cover the first electrode films and the surface of the main body. A second substrate has a second main body, a second electrode film and a second alignment film, the second alignment film being formed on a surface of the second main body. The second alignment film is formed on the second electrode film. The second substrate faces the first substrate with a distance provided between the first and the second substrates. Spacer particles are sandwiched between the first and the second alignment films and arranged above the space between the first electrode films. The spacer particles are provided on the first substrate by the method according to the one embodiment.

Hereinafter, a further embodiment will be described with reference to the drawings. In the drawings, the same or similar reference numerals denote the same portions respectively.

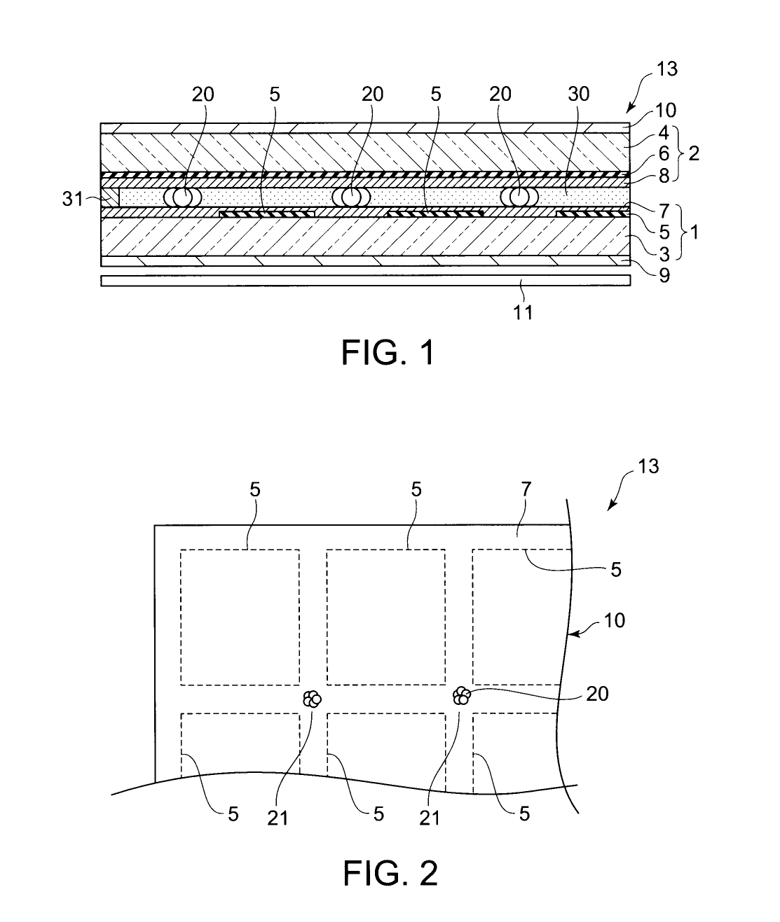

FIG. 1 is a sectional view showing an example of a liquid crystal display device manufactured by the further embodiment. As shown in FIG. 1, a liquid crystal display device 13 is provided with first and second substrates 1, 2. The first substrate 1 is provided with a first main body 3, first electrode films 5 and a first alignment film 7. The second substrate 2 is provided with a second main body 4, a second electrode film 6 and a second alignment film 8.

The first and second main bodies 3, 4 are plate-shaped and made of glass, for example, and are arranged with a space (an area) provided between the main bodies. The first and the second electrode films 5, 6 are formed of ITO (indium-tin-oxide), for example, and are arranged on surfaces of the first and the second main bodies 3, 4, respectively. The first and the second alignment films 7, 8 are formed of polyimide, for example, and are arranged on the first and the second main bodies 3, 4, so as to cover the first and the second electrode films 5, 6 respectively. The first alignment films 7 faces the second alignment films 8 with a gap provided between the films.

Between the first and the second alignment films 7, 8, a liquid crystal material 30 and spacer particles 20 are provided so as to contact with the first and the second alignment films 7, 8, respectively. The spacer particles 20 are arranged above a space between the first electrode films 5. A back light 11 is arranged on the back side of the first substrate 1.

FIG. 2 is a plane view showing the positions of spacer particles 20 schematically. The first electrode films 5 are arranged in a matrix with a space between the first electrode films and corresponding to pixel areas. The area where the first electrode films 5 are not arranged, i.e., the non-pixel area is a lattice-shaped light interception area. Interconnections (not shown) are arranged in the light interception area. Spacer particles 20 are arranged at each of regions 21, i.e., portions of a surface of the first alignment film 7 where the lattice intersects. The spacer particles 20 are clumped so that the particles may not extend to the pixel areas from the non-pixel area where the first electrode films 5 are formed.

Accordingly, the spacer particles 20 do not exist on the first electrode films 5. The liquid crystal material 30 is arranged in a gap area existing between the first and the second substrates 1, 2 and located above the first electrode film 5.

Between the first and the second substrates 1, 2, a ring-shaped sealing member 31 is arranged. The member 31 encloses the whole area where the first electrode films 5 are provided. The gap area existing above the first electrode films 5 is sealed from the outer space by the first and the second substrates 1, 2 and the sealing member. Accordingly, the liquid crystal material 30 arranged in the gap is sealed from the outer space.

The first electrode films 5 faces the second electrode film 6 via the liquid crystal material 30 and the first, and second alignment films 7, 8. The first electrode films 5 are connected to switching transistors (not shown), respectively. Each one of the switching transistors is selected so that a voltage is applied between one of the first electrode films 5 corresponding to each selected switching transistor and the second electrode film 6.

By applying the voltage, current flows in a portion of the liquid crystal material 30 located between the first and the second electrode films 5, 6 so that orientation of liquid crystal molecules is changed so as to change polarization. For example, in a case that the liquid crystal material 30 is a nematic liquid crystal, incident light is polarized in a state where current does not flow, but, in a state where current flows, incident light is not polarized and goes straight.

A first polarizing plate 9 is arranged on a surface of the first substrate 1 opposite to the first alignment film 7. A second polarizing plate 10 is arranged on a surface of the second substrate 2 opposite to the second alignment film 8.

A back light 11 is arranged at a position distant from the first polarizing plate 9 on the back side of the first substrate 1. A light from the back light 11 enters into the first polarizing plate 9 and is polarized.

The first and the second main bodies 3, 4, the first and the second electrode films 5, 6 and the first and the second alignment films 7, 8 are transparent respectively. The light polarized with the first polarizing plate 9 enters into the liquid crystal material 30 through the first electrode film 5, the main body 3 and the first alignment film 7.

The first and the second polarizing plates 9 and 10 are oriented so that the polarization directions may intersect perpendicularly to each other.

The light transmitted through the first electrode film 5, the main body 3 and the first alignment film 7 is polarized with the liquid crystal material 30, goes through the second alignment film 8, the second electrode film 6 and the second main body 4, and further is absorbed in the second polarizing plate 10.

As mentioned above, the polarization of the liquid crystal material 30 is changeable by whether a voltage is applied between the first and second electrode films 5, 6. Accordingly, by selecting each one of the first electrode films 5 and by applying a voltage to the selected electrode film, light can be radiated only from a desired area, and image information such as a figure or a character can be displayed.

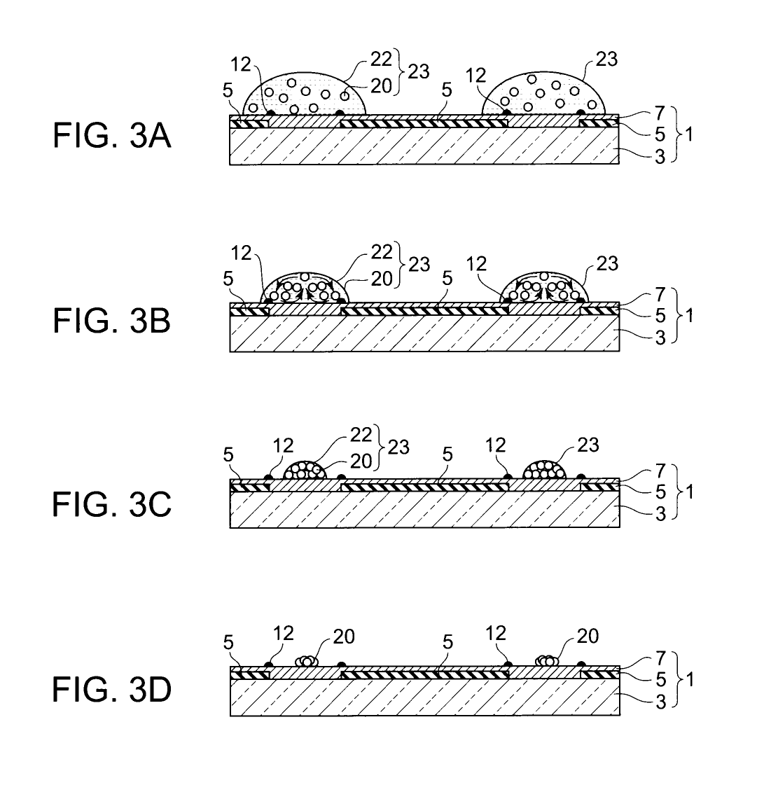

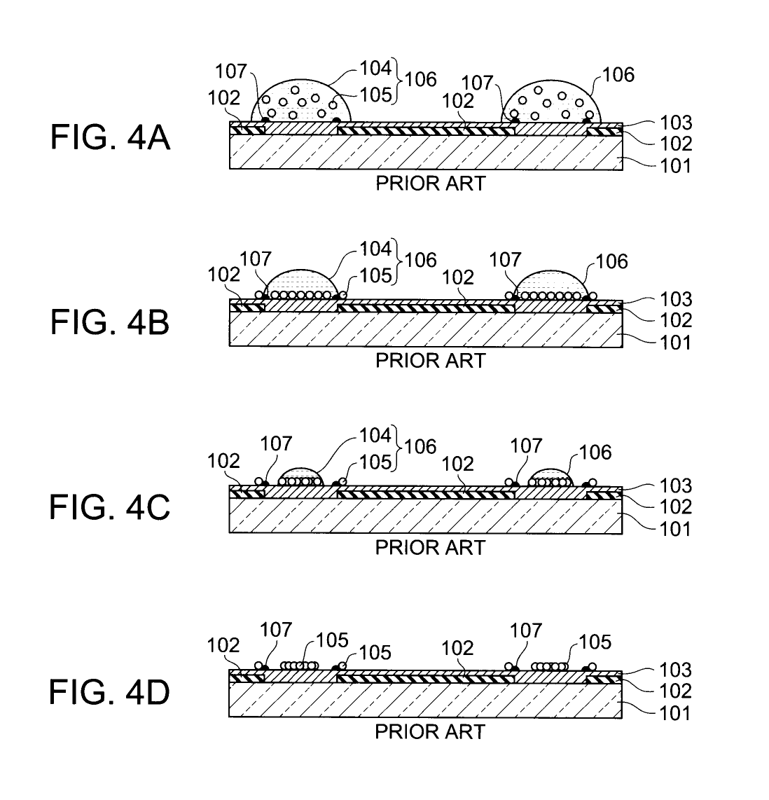

A method of manufacturing a liquid crystal display according to an embodiment will be described. FIGS. 3A-3D are sectional views showing steps of the method of manufacturing the liquid crystal display, respectively. The embodiment is a method to manufacture the liquid crystal display 13 shown in FIGS. 1, 2.

A spacer dispersed solution 23 is prepared to be used in the manufacturing method. In order to obtain the spacer dispersed solution 23, a mixture solvent 22 is produced by mixing first and second solvents. The first solvent has a specific gravity smaller than that of spacer particles 20. The second solvent has a boiling point higher than that of the first solvent. The second solvent has a surface tension larger than that of the first solvent. The second solvent has a specific gravity larger than that of the spacer particles 20. The spacer dispersed solution 23 is obtained by dispersing the spacer particles 20 into the mixture solvent 22.

As the first solvent, an alcoholic solvent such as ethanol or isopropyl alcohol may be used. As the second solvent, water or a solvent of a glycol group or an ether group may be used. The spacer dispersed solution 23 may be filled up in a device such as an ink jet printing device or a dispenser device (not shown).

First electrode films 5 are formed to be arranged in a matrix on the first substrate 1 with an interval between the films. A first alignment film 7 is formed to covers a first main body 3 of a first substrate 1 and the first electrode films 5.

As shown in FIG. 3A, droplets of the spacer dispersed solution 23 are applied onto portions of a surface of a first alignment film 7, by the device described. The portions are above a space (an area) between the first electrode films and the circumference.

The droplets coating the first alignment film 7 has a diameter of tens of micrometers, for example. This diameter is larger than the interval between the first electrode films 5, i.e., the width of a non-pixel area. Accordingly, a portion of each of the droplets becomes in a state where the portion exists on a portion of each of the first electrode films 5. In this state, it can not be definite whether the spacer particles 20 contained in the spacer dispersed solution 23 are positioned in the solution 23.

For example, as shown in FIG. 3A, in the case projections 12 exist on the portions of the first alignment films 7 located in the circumference of the first electrode films 5, the spacer particles 20 can be positioned on the outsides of the projections 12 with respect to each center position of the coated droplets of the spacer dispersed solution 23.

Then, as shown in FIG. 3B, the first substrate 1 coated with the spacer dispersed solution 23 is heated. By the heating, the first solvent contained in the mixture solvent 22 is evaporated at a low speed. As a result, the diameters of the droplets of the spacer dispersed solution 23 are reduced gradually, and spacer particles 20 are drawn to each center position of the droplets of the spacer dispersed solution 23. The heating temperature of the first substrate 1 is adjusted to a temperature so as to satisfy t1<ta, where to is a boiling point of the first solvent and where t1 is a heating temperature of the first substrate 1.

Local surface tension difference arises at a gas-liquid interface when the first solvent evaporates, since the surface tension of the first solvent is smaller than that of the second solvent. Accordingly, as shown by an arrow in FIG. 3B, convection occurs toward a side where the surface tension is larger, i.e., toward center positions of the droplets of the spacer dispersed solution 23. The convection can arise easily as the surface tension difference increases. As a result, the spacer particles 20 including those located on the outside of each projection 12 are drawn toward the center positions of the droplets of the spacer dispersed solution 23 while convection is performed.

Then, as shown in FIG. 3C, the first substrate 1 is heated so that the second solvent contained in the spacer dispersed solution 23 is gradually evaporated at a low speed. As a result, the spacer particles 20 are clumped at the center positions of the droplets of the spacer dispersed solution 23. Since the spacer particles 20 has a specific gravity smaller than that of the second solvent, the spacer particles clump in a state easy to float in the spacer dispersed solution 23 even if the diameters of the droplets of the spacer dispersed solution 23 are reduced.

In the step of FIG. 3C, the heating temperature of the first substrate 1 is adjusted to become a temperature satisfying ta<t2<tb, where the heating temperature of the first substrate 1 is t2, the boiling point of the first solvent is ta, and the boiling point of the second solvent is tb.

After the heating is completed, as shown in FIG. 3D, the spacer particles 20 are in a state that they clump at the center positions of the droplets of the spacer dispersed solution 23 provided on the first substrate 1.

After the drying processing performed by the heating is completed, a second substrate 2 shown in FIG. 1 is arranged so as to sandwich the spacer particles 20 with the first substrate 1. The second substrate 2 is obtained by forming a second electrode film 6 on a second main body 4 and further forming a second alignment film 8 which covers the second main body 4 and the second electrode film 6.

Subsequently, a liquid crystal material 30 is filled up between the first substrate 1 and the second substrate 2. Then, the circumference of the first and the second substrates 1, 2 is sealed with a sealing member so that a liquid crystal display device 13 is completed as shown in FIG. 1.

According to the embodiment, a spacer dispersed solution 23 is prepared. The spacer dispersed solution 23 is obtained by dispersing spacer particles 20 in a mixture solvent 22 of first and second solvents. The first solvent has a relatively low boiling point, and has a relatively small surface tension. The first solvent has a specific gravity smaller than that of the spacer particles. The second solvent has a relatively high boiling point. The surface tension of the second solvent is larger than that of the first solvent, and the specific gravity of the second solvent is larger than that of the spacer particles.

The spacer dispersed solution 23 is gradually evaporated by heating so that convection is caused. As a result, the spacer particles 20 are capable of clumping without remaining on the outsides of the projections 12 seen from a center position of each of the droplets of the spacer dispersed solution 23. Consequently, a reliable liquid crystal display device 13 can be manufactured.

Further, during the drying process for the spacer dispersed solution 23, the spacer particles 20 can float easily, though the spacer particles 20 are in a state where the particles are mixed in the second solvent, which has a relatively high boiling point, has a surface tension larger than that of the first solvent and has a specific gravity larger than the spacer particles 20. Accordingly, even if the projections 12 exist on places near the center positions of the droplets of the spacer dispersed solution 23 respectively, the spacer particles 20 are capable of clumping without remaining as before. As a result, a more reliable liquid crystal display device can be manufactured.

The above described embodiment is a method of manufacturing a liquid crystal display device. An FED (Field Emission Display) which is provided with spacer particles between substrates can be manufactured similarly to the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a display device, comprising:
providing droplets of a spacer dispersed solution on respective portions of a surface of a substrate which is provided with electrode films along the surface with a space provided between the electrode films, the portions being above the space between the electrode films, the spacer dispersed solution being obtained by dispersing spacer particles in a mixture solvent produced by mixing first and second solvents at least, the second solvent having a higher boiling point and a larger surface tension than those of the first solvent;
heating the substrate at a temperature lower than the boiling point of the first solvent so that the first solvent contained in the spacer dispersed solution evaporates; and
heating the substrate at a temperature higher than the boiling point of the first solvent and lower than the boiling point of the second solvent after evaporation of the first solvent so that the second solvent contained in the spacer dispersed solution evaporates so as to leave the spacer particles on the substrate.

2. A method according to claim 1, wherein the specific gravity of the first solvent is smaller than that of the spacer particles and the specific gravity of the second solvent is larger than that of the spacer particles.

3. A method according to claim 1, wherein the droplets are provided above the space between the electrode films and the circumference.

4. A method of manufacturing a display device, comprising:
providing first electrode films on a surface of a first main body of a first substrate along the surface so as to provide a space between the first electrode films, and forming a first alignment film to cover the first electrode films and the surface of the main body so that a first substrate is prepared;
providing a second electrode film on a surface of a second main body of a second substrate and forming a second alignment film on the second electrode film so that a second substrate is prepared;
providing droplets of a spacer dispersed solution on portions of a surface of the first alignment film, the portions being above the space between the first electrode films, the spacer dispersed solution being obtained by dispersing spacer particles in a solvent produced by mixing first and second solvents at least, the second solvent having a higher boiling point and a larger surface tension than those of the first solvent;
heating the first substrate at a temperature lower than the boiling point of the first solvent so that the first solvent contained in the spacer dispersed solution evaporates;
heating the first substrate at a temperature higher than the boiling point of the first solvent and lower than the boiling point of the second solvent after evaporation of the first solvent so that the second solvent contained in the spacer dispersed solution evaporates so as to leave the spacer particles on the first substrate; and
contacting the second substrate with the spacer particles so that the spacer particles are sandwiched between the first and the second alignment films.

5. A method according to claim 4, wherein the specific gravity of the first solvent is smaller than that of the spacer particles and the specific gravity of the second solvent is larger than that of the spacer particles.

6. A method according to claim 4, wherein the droplets are provided above the space between the first electrode films of the first substrates and the circumference.

7. A method according to claim 4, further comprising providing a liquid crystal material between the first and the second alignment films after sandwiching the spacer particles between the first and the second films.

8. A method according to claim 7, further comprising sealing the circumference of the first and the second substrate with a sealing member after the liquid crystal material is provided.

9. A display device, comprising:
a first substrate having a first main body, first electrode films and a first alignment film, the first electrode films being provided along a surface of the first main body with a space between the first electrode films, the first alignment film being formed to cover the first electrode films and the surface of the main body;
a second substrate having a second main body, a second electrode film and a second alignment film, the second alignment film being formed on a surface of the second main body, the second alignment film being formed on the second electrode film, the second substrate facing the first substrate with a distance provided between the first and the second substrates; and
spacer particles sandwiched between the first and the second alignment films and arranged above the space between the first electrode films,
wherein the spacer particles are provided on the first substrate by the method according to claim 1.

10. A display device according to claim 9, wherein the specific gravity of the first solvent is smaller than that of the spacer particles and the specific gravity of the second solvent is larger than that of the spacer particles.

11. A display device according to claim 9, wherein the droplets are provided above the space between the first electrode films and above the circumference of the space.

12. A display device according to claim 9, further comprising a liquid crystal material provided between the first and the second alignment films.

13. A display device according to claim 12, further comprising a sealing member to seal the circumference of the first and the second substrate.
